(19) United States
(12) Patent Application Publication
(10) Pub. No.: US 2006/0294249 A1
(43) Pub. Date: Dec. 28, 2006

(54) Communication system, communication terminal comprising virtual network switch, and portable electronic device comprising organism recognition unit

(76) Inventors: Shunichi Oshima, Kowloon (HK); Hikaru Saito, Tokyo (JP); Tomoaki Narahara, Tokyo (JP); Shogo Nakazato, Tokyo (JP); Haruhiro Kikkawa, Tokyo (JP); Takeshi Ogi, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/538,527

(22) PCT Filed: Dec. 11, 2002
(86) PCT No.: PCT/JP02/12943

§ 371 Date: Jun. 27, 2006

(51) Int. Cl. G06F 15/16

(52) U.S. Cl. 709/229

(57) ABSTRACT

The communication terminal of a communication system comprises a virtual network switch which can forcibly alter the destination of data being transmitted/received between the communication terminal and a network. Data is transmitted/received between the network and the communication terminal through a portable electronic device. Various functions, including a security function, can be supplemented by providing the function in software mounted on the portable electronic device. Even if a communication terminal connected directly with the network is not provided with such functions as a VPN, firewall or virus check, high-safety communication is ensured utilizing these security ensuring means mounted on the portable electronic device.

### FIELD OF THE INVENTION

The present invention pertains to a communication system comprising a communication terminal equipped with a network communication function and a portable electronic device capable of communicating with the communication terminal. Specifically, it pertains to a communication system capable of accessing various types of networks utilizing the communication terminal according to a communication security level preset in the portable electronic device.

### BACKGROUND OF THE INVENTION

Conventionally, it is generally the case that the software and its setting information, etc. needed when connecting a communication device to a public network such as the Internet, etc. for communication are all preloaded in the communication device, or are temporarily installed in the communication device, and the software is operated in the communication device. When ensuring security during communication, the software for ensuring security is preloaded or temporarily installed in the communication device.

Ensuring security during communication also includes VPN technology, which ensures security by utilizing some shared circuits as virtual dedicated circuits by using specially encrypted data to communicate with the other party; firewall technology, which prevents information exchange with unwanted others during communication; illegal virus removal technology, which checks whether or not malicious virus software is hidden in exchanged data and removes it, etc.

IP-VPN technology is widely used in VPN technology in order to prevent the risk of data being surreptitiously monitored or falsified by unknown strangers when communicating on the Internet. When IP-VPN technology is used, a network engineer installs prespecified VPN client software in the communication terminal of the client terminal that is to communicate and makes the necessary settings, thereby enabling connection with a specified VPN gateway device. When the client terminal communicates with a remote location, it employs encrypted communication via the VPN gateway device, thereby making it possible to communicate safely with the remote location over the Internet.

With firewall technology it is possible to do simple settings using software that is normally loaded in the OS of a communication terminal in advance. But when used in a company, etc., it is generally the case that firewall software is purchased and put in each communication terminal, or is set up at the entry to a network and used to protect the network itself. Both cases generally require settings be made in advance by an expert, so typically this is a protective method targeting a specific terminal or a specific network.

In addition, illegal virus removal technology is generally such that, like the aforesaid firewall technology, the virus removal software is put in a communication terminal in advance and the removal operation is performed periodically, or the virus removal software is put in a specific server device on a network and viruses are eliminated at the server when communicating via that device.

Conventional technology often assumes that when communication begins, all of the software needed has already been loaded into the network device. Nevertheless, there are a vast number of ways of connecting to a network, which is typically the Internet in today's society, and individuals can freely utilize networks at their own volition without going through a network device that is pre-controlled by a network administrator. Currently, network control and information control in a limited area by a network administrator is, in practice, meaningless. Thus, there is an urgent need to provide to the individual who is trying to access a network, network management tools. Nowadays, Internet cafes and public wireless services provide network access. It is difficult to know to what extent the companies that operate and manage the circuits and terminals of such cafes and services have taken security protective measures. It appears desirable that when someone is using a communication terminal, that person should provide his own protective measures.

Meanwhile, from the standpoint of the processing ability of the communication terminal itself, the following sort of difficulties arise. The processing ability required of the software and hardware in a communication terminal is steadily increasing, year after year. The processing ability of the communication terminal is likewise steadily rising. Even though the processing ability of the communication terminal is increasing, when a single communication terminal does all sorts of tasks, the communication terminal's ability to execute applications that it is supposed to execute for a user is limited. Sometimes there are tasks related to communication that must be executed.

The amount of transmitted information has increased as networks have become faster, and there is a tendency for problems created by this increase to occur more frequently. From the user's standpoint, the problem created by the delays in executing some tasks becomes the reason for purchasing a new communication terminal. As a result, efficiency is bad. Also, in the case of a user who communicates using many communication terminals, the state of the communication environment becomes dependent on the abilities of individual terminals. As a result, network quality is unavoidably unstable.

When communicating using individual security technologies, such as VPN technology, for example, one must assume that VPN client software has been installed in the client terminal and that the necessary communication settings have already been made. These communication settings are usually very detailed network configurations, and are difficult to set unless one knows all of the setting information needed by the destination VPN gateway.

As a result, terminals using VPN communication are limited to information terminals that a company has preset and assigned to an employee. Unless an employee carries around the assigned information terminal, it is impossible in practice to communicate with company resources using a VPN connection. The only solutions are for the employee to make a low-speed dial-up connection using a public circuit, or to do a limited mail access using a service provided by a third-party Internet service provider, wireless telephone carrier, etc. that is not affected by the company administrator's security management. However, such methods are basically risky for the network administrator and not desirable.

Also, the various types of communication setting information set in VPN client software can easily be accessed by a third party other than the communication terminal owner if it passes through a simple security check. Therefore a malicious third party could intercept the setting information with relative ease from the terminal of a careless client terminal owner, set another terminal, connect with the VPN gateway, and thereby be able to access the company's confidential data.

Furthermore, when utilizing firewalls or virus removal software, employing conventional technology there are limits to the networks and communication terminals on which they can be used. The current situation is that there is no means for safely using the ubiquitous Internet without restricting the communication terminal itself that is actually communicating.

### SUMMARY OF THE INVENTION

The present invention is directed to providing a communication system capable of communicating at the desired security level using a communication terminal without the assumption that all of the necessary software has been preloaded in the communication terminal equipped with a communication function, and to provide a communication terminal and portable electronic device for use in this communication system.

An exemplary embodiment of the communication system is characterized by: a communication terminal including a network connector, and a portable electronic device capable of communicating with the communication terminal. The communication terminal comprises a virtual network switch that can forcibly alter the destination of data transmitted to and from a network connected via the network connection. The portable electronic device includes a security ensurer for ensuring communication security to and from the network using the communication terminal. The communication terminal transmits data to and from the network via the virtual network switch and the security ensurer of the portable electronic device.

The security ensurer can include a VPN module, a virus removal module, and/or a firewall, for example.

The virtual network switch can be a virtual IP switch incorporated into the network layer in the OSI 7-layer model in TCP/IP, the standard Internet protocol, for example. Such a virtual IP switch can transfer packets received from the network to a higher transport layer or to the portable electronic device according to preset parameters, and returns packets from the portable electronic device to a higher transport layer or to the network that was the transmission source according to preset parameters.

Preferably, the inventive communication system, in addition to the aforesaid constitution, is characterized by the checking of the security of the communication terminal's storage medium and applications being performed by the portable electronic device's security ensurer via the virtual network switch.

Also, the portable electronic device preferably comprises an organism recognition device such as a fingerprint sensor, etc., an organism information storage unit in which organism information is prestored and held, and an authenticator for permitting access to the network via the communication terminal by comparing organism information read by the organism recognition device against organism information stored in the organism information storage unit.

Another exemplary embodiment of the communication system is characterized by: a communication terminal including a network connector, and a portable electronic device capable of communicating with the communication terminal; the communication terminal comprises a security ensurer for ensuring communication with a network; and the portable electronic device preferably comprises a communication setting information storage unit that stores and holds communication setting information needed for communication with the network via the security ensurer, an organism recognition device such as a fingerprint sensor, etc., an organism information storage unit in which organism information is prestored and held, and an authenticator for comparing organism information read by the organism recognition device against organism information stored in the organism information storage unit.

The inventive communication system, constituted in this manner, is not limited by the type of software loaded in a communication terminal having a network communication function; the communication terminal is supplied with the functions of the software loaded in the portable electronic device. Various types of functions such as security functions, etc. can be supplemented. Therefore, even if a communication terminal directly connected to a network is not equipped with functions such as a VPN, firewall, virus check, etc., high safety communication is possible by using the security ensurers loaded in the portable electronic device.

Also, the portable electronic device itself does not have an intrinsic physical network connector, but when it is connected to a separate communication terminal directly connected to a network the portable electronic device is virtually present between the network and the communication terminal due to the communication terminal's virtual network switch. Therefore the communication terminal and the network can communicate utilizing the security ensurer loaded in the portable electronic device.

In addition, when the portable electronic device includes an organism recognition device, authenticating the person using the organism recognition device makes it possible to establish a connection to a specified network on the Internet through a communication terminal connected to the network by an intrinsic physical connection (such as a PC, wireless phone, etc.) to which the device is connected.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram showing the structure of one example of a communication system employing the present invention;

FIG. 2 is a block diagram showing the structure of another example of a communication system employing the present invention;

FIG. 3 is a block diagram showing the structure of yet another example of a communication system employing the present invention;

FIG. 4 is a diagram explaining an example of the virtual network switch provided in the communication terminal in the communication systems of FIG. 1 through FIG. 3;

FIG. 5 is a diagram explaining an example of the virtual network switch provided in the communication terminal in the communication systems of FIG. 1 through FIG. 3;

FIG. 6 is a block diagram showing the structure of one example of a communication system according to another arrangement of the present invention;

FIG. 7 is a block diagram showing the structure of a variation of the FIG. 6 communication system; and

FIG. 8 is a block diagram showing the structure of another variation of the FIG. 6 communication system.

### DETAILED DESCRIPTION OF THE PREFERRED EMBODIMENT

Embodiments of communication systems employing the present invention are explained below with reference to the drawings.

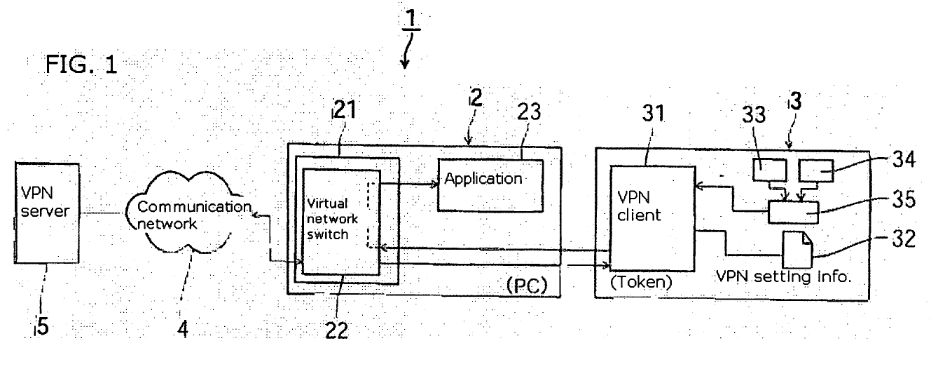

FIG. 1 is a block diagram showing the structure of one example of a communication system employing the present invention. This example's communication system 1 includes a communication terminal 2 equipped with a network connector 21 such as a PC, portable telephone, etc., and a portable electronic device 3 (hereinafter “token”) capable of communicating with the communication terminal 2. The communication terminal 2 can connect to a designated network 5, such as a VPN server, via a communication network 4 such as the Internet.

The communication terminal 2 includes a virtual network switch 22 that can forcibly alter the destination of data transmitted to and from the network 5 to which it is connected via the network connector 21. Using the virtual network switch 22, data sent from the network 5 to the communication terminal 2 is transferred to the portable electronic device 3, passes through the portable electronic device 3, and is returned again to the virtual network switch 22 of the communication terminal 2, and then is processed by an application 23 of the communication terminal 2, etc. Data sent from the communication terminal 2 to the network 5 also goes from the virtual network switch 22 to the portable electronic device 3 and passes through the virtual network switch 22 again and is sent toward the destination network 5. Thus, while the portable electronic device 3 is physically connected to the communication terminal 2, it functions as if it were interposed between the network 5 and the communication terminal 2 due to the virtual network switch 22.

The portable electronic device 3 has a security ensurer for ensuring communication security with the network 5 using the communication terminal 2. In this example, the security ensurer includes a VPN client function 31 and a storage unit 32 for storing VPN setting information.

In this example, communication system 1, after the portable electronic device 3 is connected to the communication terminal 2 and they can communicate with one another, when communication with the network 5 (i.e., the VPN server) starts using the network connector 21 of the communication terminal 2, the virtual network switch 22 functions. As a result, communication utilizing the VPN client 31 of the portable electronic device 3 is formed between the network 5 and the communication terminal 2.

It is preferred that the portable electronic device 3 have an organism recognition device 33 such as a fingerprint sensor, etc., an organism information storage unit 34 in which organism information is prestored and held, and an authenticator 35 for authenticating by comparing organism information read by the organism recognition device 33 against organism information stored in the organism information storage unit 34.

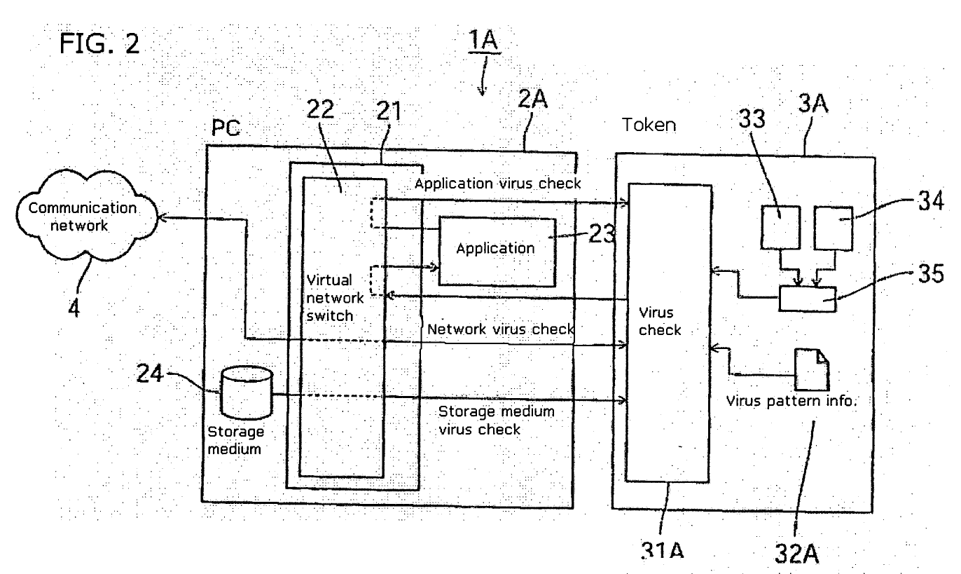

FIG. 2 is a block diagram showing the structure of another example of a communication system 1A employing the present invention. The communication system 1A shown in this drawing is constituted so that management of the media (hard disk, removable disk, external memory, etc.) of a communication terminal 2A and program execution management are handled from a portable electronic device 3A utilizing the function of the virtual network switch 22.

The virtual network switch 22 of the communication terminal 2A has a function for accessing the storage media (hard disk, removable disk etc.) of the communication terminal 2A. The portable electronic device 3A is provided with a virus check module 31A and a virus pattern information storage unit 32A as the security ensurer.

After the portable electronic device 3A connects to the communication terminal 2A and the person is authenticated, the virus check module 31A issues a command packet to the virtual network switch 22 of the communication terminal 2A for accessing the storage medium 24 and the application 23. Thus a security check of the various media of the communication terminal can be conducted from the portable electronic device 3A.

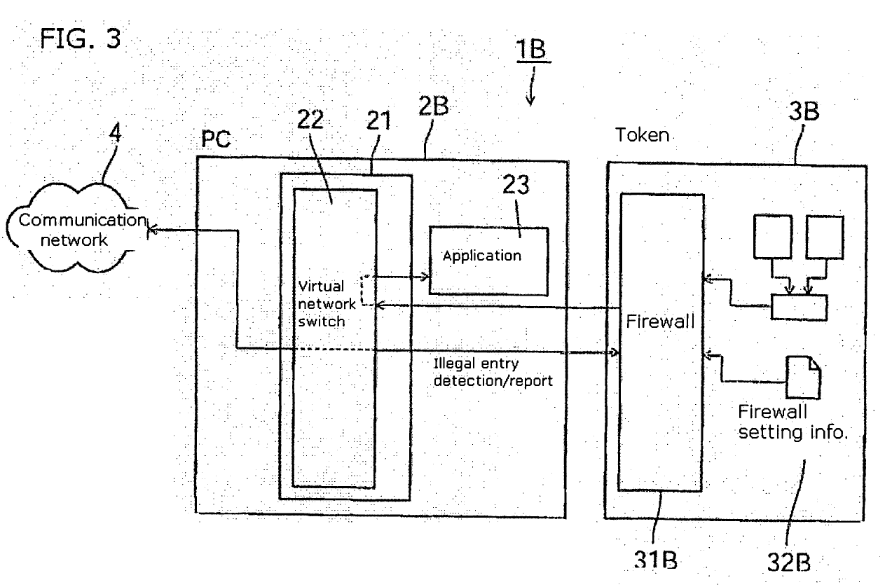

FIG. 3 is a block diagram showing the structure of yet another example of a communication system 1B employing the present invention. The communication system 1B shown in this drawing is constituted so that a firewall function 31B and a storage unit 32B for storing firewall setting information are provided in a portable electronic device 3B as the security ensurer. In this communication system 1B the portable electronic device 3B is virtually present between the communication network 4 and the communication terminal 2B due to the function of the virtual network switch 22, and detects and reports illegal entry from the outside, so safe communication is possible.

The virtual network switch 22 provided in the communication terminal 2, 2A, or 2B can be a virtual IP switch incorporated into the network layer in the OSI 7-layer model in TCP/IP, the standard Internet protocol.

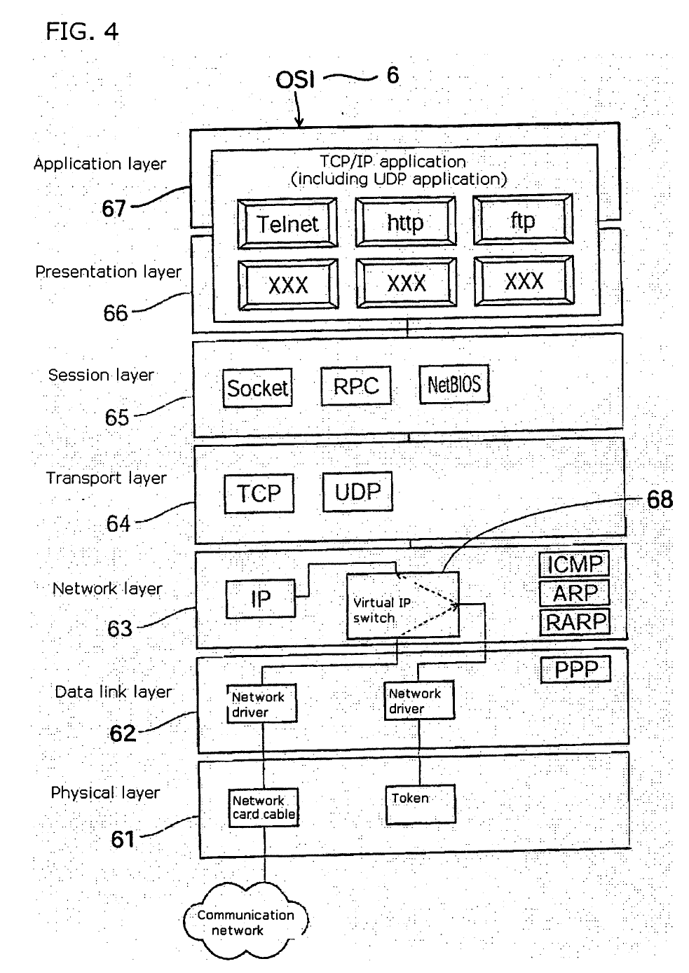

FIG. 4 is a diagram explaining the OSI 7-layer model. A virtual IP switch 68 is installed in a network layer 63 in a 7-layer model 6. The virtual IP switch 68 switches the packet destination to a higher transport layer 64 or to the portable electronic device 3, 3A, or 3B of another network device. No change to the various other layers 61, 62, and 64-67 is necessary.

The virtual IP switch 68 has a different mechanism than the usual layer-3 switch; when a packet is transferred to the portable electronic device 3, 3A, or 3B, it is necessary to maintain the original packet's information without loss, so the original packet needs to be encapsulated as a packet for transfer. The encapsulated packet is restored to the original packet at the destination device 3, 3A, or 3B, is processed by an application at the device, and the packet is passed to the virtual IP switch 68 again.

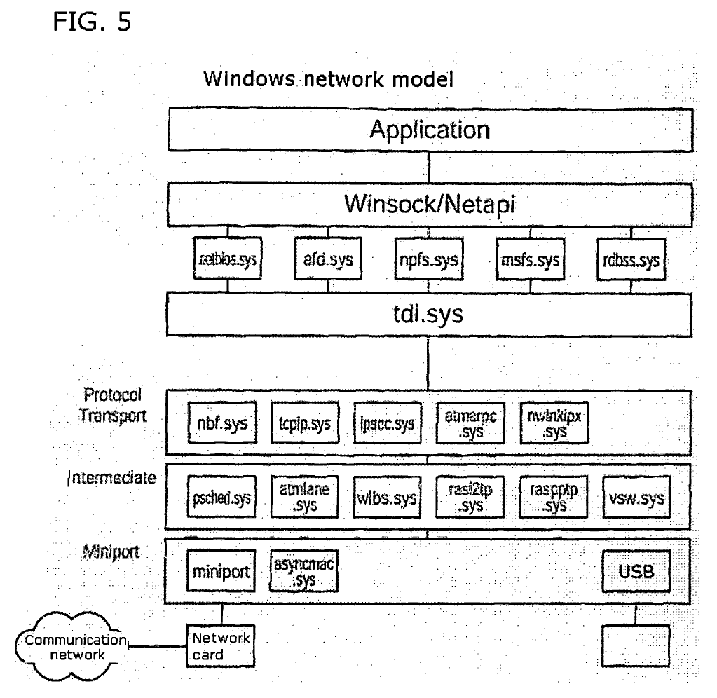

FIG. 5 is a drawing explaining the case when the 7-layer model is applied to a Windows® network model. In this drawing, “vsw.sys” in the intermediate layer is the virtual network switch. The software decides whether to transfer a packet to one of the higher protocols in the portable electronic device 3, 3A, or 3B and the communication terminal 2, 2A, or 2B. The intermediate layer is a layer commonly used in the Windows network architecture; packet filtering software that utilizes this layer is commercially available.

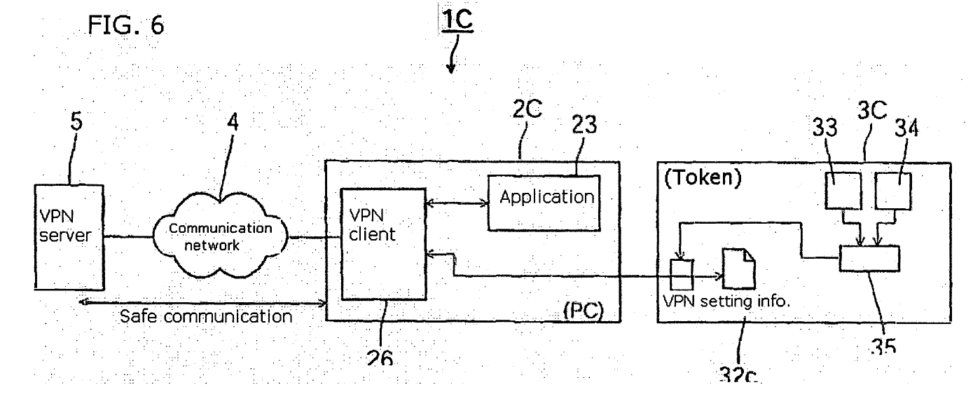

Next, FIG. 6 is a block diagram showing the structure of a communication system 1C according to the present invention. The communication system 1C has a communication terminal 2C and a portable electronic device (token) 3C. The communication terminal 2C has a network connector 21A and a VPN client 26. The portable electronic device 3C has a storage unit 32C for storing the VPN setting information needed for communication using the VPN client 26. The portable electronic device 3C also includes the organism recognition device 33 such as a fingerprint sensor, etc., the organism information storage unit 34 in which organism information is prestored and held, and the authenticator 35 for authenticating by comparing organism information read by the organism recognition device 33 against organism information stored in the organism information storage unit 34.

The communication system 1C with this constitution puts the program that processes security on the communication terminal 2C side, and keeps the information necessary for operating it on the token (portable electronic device) 3C side; they work together and execute processing according to the result of recognition by the organism recognition device 33.

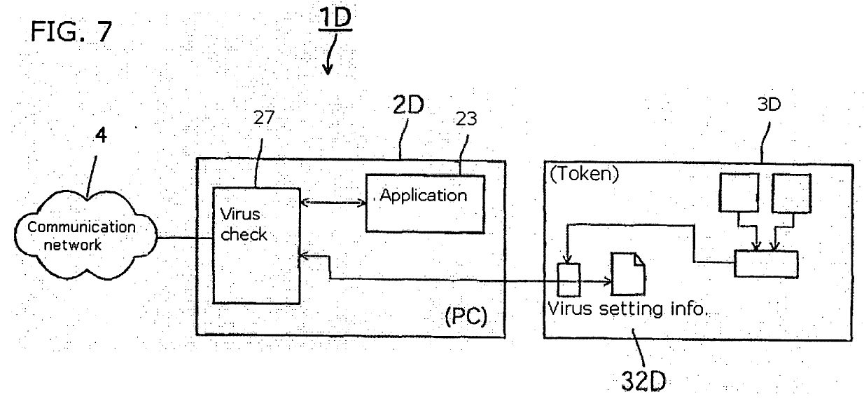

FIG. 7 is a block diagram showing the structure of a communication system ID with a virus check function employing the present invention. In this communication system ID a virus check function (software) 27 is put on the communication terminal 2D side, and the virus setting information needed for executing it is held in the storage unit 32D of a portable electronic device 3D. When authenticated by the organism recognition device 33, the two work together and perform a virus check, and safe communication is possible.

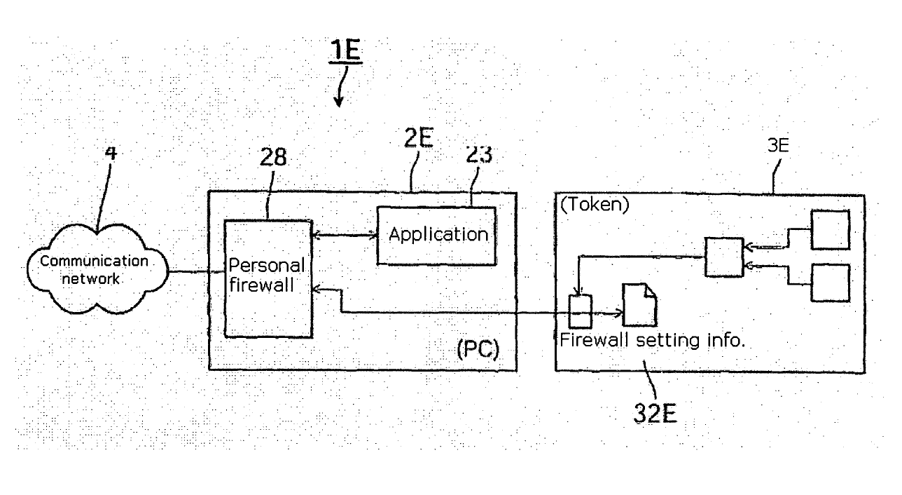

FIG. 8 is a block diagram showing the structure of a communication system 1E with a firewall function employing the present invention. In this communication system IE a personal firewall function 28 is put on the communication terminal 2E side, and the portable electronic device 3E has a storage unit 32E for storing firewall setting information therefor. In this case too, when a person is authenticated by the organism recognition device 33, the two work together and safe communication is possible.

As explained above, the communication system, including the communication terminal and portable electronic device, provide the following sort of effects.

(1) Carrying around a portable electronic device with an organism recognition device allows a user to use any communication terminal having a network communication function anywhere to communicate safely with a required resource on the Internet while performing a VPN connection or security check. Therefore it is possible to communicate using the best useable communication means while maintaining one's own security policy at the necessary location without being limited to the security set by the circuit provider.

(2) It is not necessary to keep information that threatens security in the communication terminal. VPN connection and personal firewall settings, virus check settings, and other communication setting information that pertains to security is encrypted and kept in the portable electronic device, so the risk of setting information leaking to an outside third party is greatly reduced.

(3) The load on communication terminals occasioned by security checks is reduced, and one can expect improvement in the performance of other processing.

(4) In connection with (2) above, in ordinary use, it is essentially unnecessary for the user himself to become involved in operating VPN client software, etc. Also, it becomes possible to make accessing the setting information a restricted task using encryption means that only a network administrator can use, thereby greatly reducing the risk of someone carelessly altering a client software's setting information. As a result, one can expect a reduction in a network administrator's work and a company's administrative costs.

(5) An individual can carry the inventive portable electronic device as an ID, and can save VPN software that works with that ID, a personal firewall, virus check software, and connection-related communication setting information. By doing so, the company that loaned the device does not have to do tasks such as installing VPN client software in a newly used communication device or making settings for VPN connection when an employee/user is moved to a different post or when replacing communication devices such as the PC that is being used. All that is needed is to ensure a communication interface with the relevant token. As a result, the network administrator's work is greatly reduced.

(6) In connection with the aforesaid ID, by linking the inventive scheme with software such as security software, etc. it becomes possible to authenticate a person using an organism recognition device, check license information by issuing the ID to a network server after authentication, provide an update function for software installed in the token after the license check, etc. This can be reliably done vis-a-vis the person carrying the device, not vis-a-vis the terminal.

(7) If the specifications of a communication terminal are such that it cannot provide the application or communication software functions that are being used, instead of buying a new communication terminal it is possible to switch only the required communication processing ability to another distributed processing device and to carry around this sort of distributed processing device; therefore one can always have a stable communication environment without carrying around the terminal itself.

While the preferred embodiment of the invention has been illustrated and described, it will be appreciated that various changes can be made therein without departing from the spirit and scope of the invention.

1-10. (canceled)

11. A communication system comprising:
a communication terminal including a network connector, the communication terminal also including a virtual network switch that can forcibly alter the destination of data transmitted to and from a network connected via the network connector; and
a portable electronic device capable of communicating with the communication terminal, the portable electronic device including a security ensurer for ensuring communication security to and from said network using said communication terminal, wherein the communication terminal transmits data to and from said network via said virtual network switch and said security ensurer of said portable electronic device.

12. A communication system according to claim 1, wherein said portable electronic device includes an organism recognition device, an organism information storage unit in which organism information is prestored and held, and an authenticator for permitting access to said network via said communication terminal by comparing organism information read by said organism recognition device against organism information stored in said organism information storage unit.

13. A communication system according to claim 2, wherein the organism recognition device is a fingerprint sensor.

14. A communication system according to claim 1, wherein checking the security of said communication terminal's storage medium and applications is performed by said security ensurer of said portable electronic device via said virtual network switch.

15. A communication system according to claim 4, wherein said portable electronic device includes an organism recognition device, an organism information storage unit in which organism information is prestored and held, and an authenticator for permitting access to said network via said communication terminal by comparing organism information read by said organism recognition device against organism information stored in said organism information storage unit.

16. A communication system according to claim 5, wherein the organism recognition device is a fingerprint sensor.

17. A communication system according to claim 1, wherein said security ensurer includes at least one of an encryption data transmission module, a virus removal module, and a firewall.

18. A communication system according to claim 7 wherein the encryption data transmission module is a VPN client.

19. A communication system according to claim 7, wherein said portable electronic device includes an organism recognition device, an organism information storage unit in which organism information is prestored and held, and an authenticator for permitting access to said network via said communication terminal by comparing organism information read by said organism recognition device against organism information stored in said organism information storage unit.

20. A communication system according to claim 9, wherein the organism recognition device is a fingerprint sensor.

21. A communication system according to claim 7, wherein checking the security of said communication terminal's storage medium and applications is performed by said security ensurer of said portable electronic device via said virtual network switch.

22. A communication system according to claim 4, wherein said portable electronic device includes an organism recognition device, an organism information storage unit in which organism information is prestored and held, and an authenticator for permitting access to said network via said communication terminal by comparing organism information read by said organism recognition device against organism information stored in said organism information storage unit.

23. A communication system according to claim 12, wherein the organism recognition device is a fingerprint sensor.

24. A communication system according to claim 1 or claim 7, wherein said virtual network switch is a virtual IP switch incorporated into the network layer of the OSI 7-layer model in TCP/IP, the standard Internet protocol, said virtual IP switch transferring packets received from said network to a higher transport layer or to said portable electronic device according to preset parameters, and returning packets from the portable electronic device to a higher transport layer or to said network that was the transmission source according to preset parameters.

25. A communication system according to claim 14, wherein said portable electronic device includes an organism recognition device, an organism information storage unit in which organism information is prestored and held, and an authenticator for permitting access to said network via said communication terminal by comparing organism information read by said organism recognition device against organism information stored in said organism information storage unit.

26. A communication system according to claim 15, wherein the organism recognition device is a fingerprint sensor.

27. A communication system according to claim 14, wherein checking the security of said communication terminal's storage medium and applications is performed by said security ensurer of said portable electronic device via said virtual network switch.

28. A communication system according to claim 17, wherein said portable electronic device includes an organism recognition device, an organism information storage unit in which organism information is prestored and held, and an authenticator for permitting access to said network via said communication terminal by comparing organism information read by said organism recognition device against organism information stored in said organism information storage unit.

29. A communication system according to claim 18, wherein the organism recognition device is a fingerprint sensor.

30. A communication terminal comprising a network connector and a virtual network switch that can forcibly alter the destination of data transmitted to and from a network connected via the network connector.

31. A communication terminal as claimed in claim 20, wherein said virtual network switch is a virtual IP switch incorporated into the network layer of the OSI 7-layer model in TCP/IP, the standard Internet protocol, the virtual IP switch transferring packets received from said network to a higher transport layer or to a portable electronic device according to preset parameters, and returning packets from the portable electronic device to a higher transport layer or to said network that was the transmission source according to preset parameters.

32. A portable electronic device capable of communicating with a communication terminal comprising a security ensurer for ensuring communication security to and from a network using a communication terminal, the communication terminal transmitting data to and from said network via a virtual network switch and said ensurer.

33. A portable electronic device according to claim 22 including an organism recognition device, an organism information storage unit in which organism information is prestored and held, and an authenticator for permitting access to said network via said communication terminal by comparing organism information read by said organism recognition device against organism information stored in said organism information storage unit.

34. A portable electronic device according to claim 23 wherein said organism recognition device is a fingerprint sensor.

35. A portable electronic device according to claim 22 wherein the security of said communication terminal's storage medium and applications is checked by said security ensurer via said virtual network switch.

36. A portable electronic device according to claim 25 including an organism recognition device, an organism information storage unit in which organism information is prestored and held, and an authenticator for permitting access to said network via said communication terminal by comparing organism information read by said organism recognition device against organism information stored in said organism information storage unit.

37. A portable electronic device according to claim 26 wherein said organism recognition device is a fingerprint sensor.

38. A portable electronic device according to claim 22 wherein said security ensurer includes at least one of an encryption data transmission module, a virus removal module, and a firewall.

39. A portable electronic device according to claim 28 wherein the encryption data transmission module is a VPN client.

40. A portable electronic device according to claim 28 including an organism recognition device, an organism information storage unit in which organism information is prestored and held, and an authenticator for permitting access to said network via said communication terminal by comparing organism information read by said organism recognition device against organism information stored in said organism information storage unit.

41. A portable electronic device according to claim 30 wherein said organism recognition device is a fingerprint sensor.

42. A portable electronic device according to claim 28 wherein the security of said communication terminal's storage medium and applications is checked by said security ensurer via said virtual network switch.

43. A portable electronic device according to claim 32 including an organism recognition device, an organism information storage unit in which organism information is prestored and held, and an authenticator for permitting access to said network via said communication terminal by comparing organism information read by said organism recognition device against organism information stored in said organism information storage unit.

44. A portable electronic device according to claim 33 wherein said organism recognition device is a fingerprint sensor.

45. A communication system comprising:
a communication terminal comprising a network connector, the communication terminal including a security ensuring means for ensuring communication security to and from a network; and
a portable electronic device capable of communicating with the communication terminal, the portable electronic device including a communication setting information storage unit that stores and holds communication setting information needed for communication with a network via said security ensurer, an organism recognition device, an organism information storage unit in which organism information is prestored and held, and an authenticator for comparing organism information read by said organism recognition device against organism information stored in said organism information storage unit.

46. A communication system according to claim 35, wherein the organism recognition device is a fingerprint sensor.

47. A communication system according to claim 35, wherein said security ensurer includes at least one of an encryption data transmission module, a virus removal module, and a firewall.

48. A communication system according to claim 37 wherein the encryption data transmission module is a VPN client.

49. A communication system according to claim 37, wherein the organism recognition device is a fingerprint sensor.

50. A portable electronic device capable of communicating with a communication terminal, comprising a communication setting information storage unit that stores and holds communication setting information needed for communication with a network via a security ensurer, an organism recognition device, an organism information storage unit in which organism information is prestored and held, and an authenticator for comparing organism information read by said organism recognition device against organism information stored in said organism information storage unit.

51. A portable electronic device according to claim 40, wherein the organism recognition device is a fingerprint sensor.

52. A portable electronic device according to claim 41, wherein said security ensurer includes at least one of an encryption data transmission module, a virus removal module, and a firewall.

53. A portable electronic device according to claim 42 wherein the encryption data transmission module is a VPN client.

54. A portable electronic device according to claim 40, wherein said security ensurer includes at least one of an encryption data transmission module, a virus removal module, and a firewall.

55. A portable electronic device according to -Claim 44 wherein the encryption data transmission module is a VPN client.
